(19) United States
(12) Patent Application Publication
(10) Pub. No.: US 2007/0184765 A1
(43) Pub. Date: Aug. 9, 2007

(54) Tool for working on a surface

(76) Inventor: Kent V. Annis, Burnsville, MN (US)

Correspondence Address: Brooks & Cameron, PLLC, Suite 500, 1221 Nicollet Avenue, Minneapolis, MN, 55403, US

(21) Appl. No.: 11/651,906

(22) Filed: Jan. 9, 2007

Related U.S. Application Data
(63) Continuation-in-part of application No. 11/271,374, filed on Nov. 10, 2005.
Application No. 11/271,374 is a continuation of application No. 10/439,836, filed on May 16, 2003, now Pat. No. 6,991,529.

(51) Int. Cl. B23F 21/03

(52) U.S. Cl. 451/557

(57) ABSTRACT

An embodiment of a tool for working on a surface includes a rigid tool support, a pad attached to a lower surface of the rigid tool support, a working material replaceably attached to a lower surface of the pad, and a vacuum attachment member connected to the rigid tool support, the vacuum attachment member including an outlet for releasable attachment to a vacuum source.

### RELATED APPLICATIONS

The present application is a continuation in part (CIP) of U.S. patent application Ser. No. 11/271,374, filed on Nov. 10, 2005, which is a continuation of application Ser. No. 10/439,836, filed on May 16, 2003, now U.S. Pat. No. 6,991,559, the disclosures of which are incorporated in their entirety herein by reference.

### INTRODUCTION

Hand held tools have been utilized in many fields for working the surface of a material, such as sanding, polishing, and painting, among others. For example, when fabricating a structure, such as a wall or ceiling in a building, oftentimes it is necessary to utilize a sanding device to smooth the surface of the structure. In response to this need, in the field of sanding devices for example, devices have been proposed.

One device utilizes a sanding head having an elongate rectangular head. This head is designed to accommodate a standard sized elongate sheet of sand paper, thereby making the supply of sanding paper readily accessible. However, when the device is manipulated, due to its narrow configuration, the device tends to flip onto its elongate sides and can damage the surface of the wall, for example by gouging the surface with the corners or edges of the device, requiring filling or additional sanding to remove the damage.

A device has also been proposed to aid in sanding corners that utilizes an acute isosceles triangular shape. However, since the isosceles triangle has a tall narrow profile, this device also has a narrow region near the attachment to the handle and encounters the same flipping problem.

Additionally, the angles do not match that of most corners on surfaces and therefore, a corner of the device needs to be moved around the area of the corner of the surface in order to completely work such an area. This approach can lead to uneven sanding and increases the risk of poking the corner of the device into one of the adjacent walls forming the corner.

Another device utilizes a motorized rotating head that rotates rapidly to reduce the number of passes the device must take over an area. These devices are larger and more cumbersome due to the mechanical motor assembly and have a circular, non-continuous “O” shaped working surface due to the need to have access to a bolt. The bolt is seated in the center of the “O” defined by the working surface. The bolt is used to remove it from the rotational axis of the device in order to remove the sanding or other type of working material mounted to the head. This device takes a greater level of skill to master and if used improperly, can damage the surface by dishing to create swirl marks in the surface.

### BRIEF DESCRIPTION OF THE DRAWINGS

FIG. 1 illustrates a top perspective view of an embodiment of a device head attached to a handle.

FIG. 2A illustrates a side view of the embodiment of FIG. 1.

FIG. 2B illustrates a side view of another embodiment of a device head.

FIG. 2C illustrates a side view of another embodiment of a device head.

FIG. 3 illustrates a bottom perspective view of another embodiment of a device head attached to a handle.

FIG. 4 illustrates a top perspective view of an embodiment of a device head attached to a handle.

FIG. 5A illustrates a side view of the embodiment of FIG. 4.

FIG. 5B illustrates a side view of another embodiment of a device head.

FIG. 6A illustrates a top view of another embodiment of a device head attached to a handle.

FIG. 6B illustrates a top view of another embodiment of a device head attached to a handle.

FIG. 7 illustrates a cross sectional view of a tool having a vacuum attachment member according to an embodiment of the present disclosure.

### DETAILED DESCRIPTION

Embodiments of the present invention provide working devices that reduce the potential for tipping of a head of the device on its side.

As one of ordinary skill in the art will appreciate upon reading this disclosure, a working device can be utilized in many fields depending upon what working material is utilized.

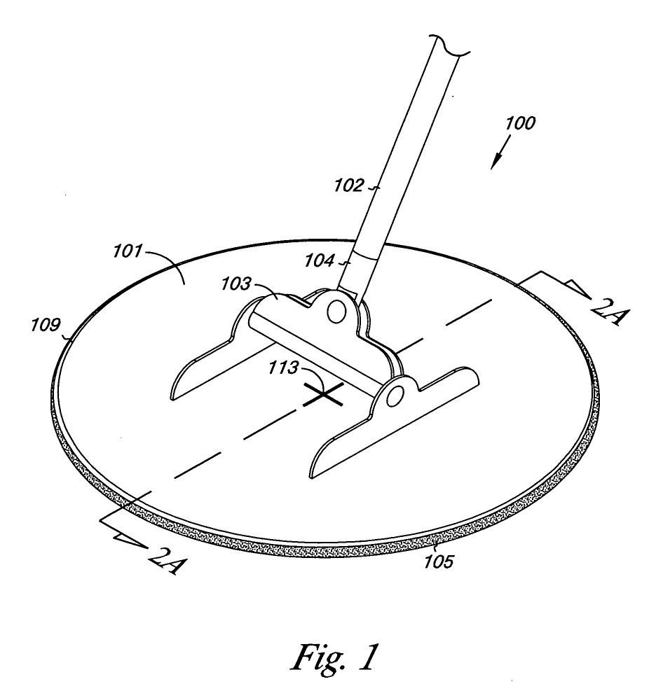

FIG. 1 illustrates a top perspective view of an embodiment of a device head 100 attached to a handle 102. In this embodiment, the handle 102 is an elongate handle, such as a broom handle, dowel, or extended pole, however, the invention is not so limited.

In FIG. 1, the device head 100 includes a tool support 101 that can be attached to the handle 102 in any manner. For example, as shown in FIG. 1, the tool support 101 can be attached to the handle 102 by a pivoting structure. In the example shown, a two piece, two directional structure is provided. In this example, a first piece 103 having a first pivoting point is connected to a second piece 104 also having a pivot point. The first piece 103 allows the handle 102 to pivot radially with respect to the attachment point of the handle 102 to the tool support 101.

In this embodiment, the second piece 104 allows the handle 102 to pivot radially with respect to the attachment point of the handle 102 to the tool support 101, but generally perpendicular to the pivotal movement provided by the first piece 103. The use of the two pieces 103 and 104 allows for the handle 102 to achieve many positions with respect to the tool support 101, however, the invention is not limited to the use of the two pivotable attachment pieces shown. For example, a ball joint or other universal joint type structure can be utilized. In some embodiments, the handle 102 can be fixed with respect to the tool support 101.

In the embodiment shown in FIG. 1, the tool support 101 has a pad 105 attached to the lower surface of the support 101. The pad 105 can be a rigid, i.e. inflexible, or resilient material. In an embodiment, where the pad 105 is a resilient material it can be utilized, for example, to cushion the force of the support 101 on the surface being worked on. In an embodiment where the pad 105 is an inflexible material, it can be utilized to distribute force more directly to the surface being worked on.

The pad 105 can be fabricated from a working material or can have a working material attached thereto. A working material can be any type of material that can be utilized to perform work on a surface. Some examples of working materials include, but are not limited to abrasive materials such as sand paper, materials for the application of paint or stain, and materials for polishing, among others. The attachment of the pad 105 to the support 101 can be accomplished in any manner.

As shown in FIG. 1, the support 101 has a periphery 109 defined by its outside edge and the periphery 109 has many points that are equidistant from the center 113 of the support 101. In some embodiments, the handle 102 is attached such that it is centered on the surface of the support 101.

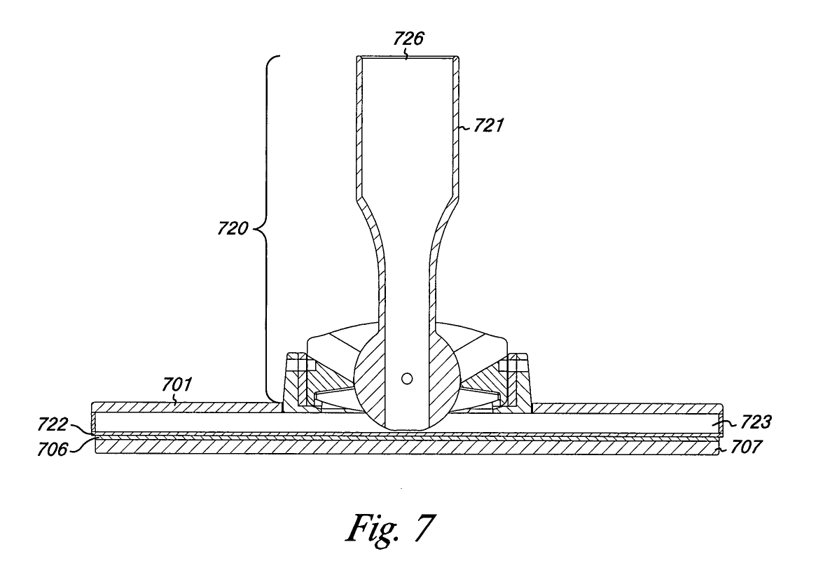

In some embodiments, and as described further in connection with FIG. 7, the tool head can include a vacuum attachment member connected to the tool support. In such embodiments, the vacuum attachment member can include an outlet for releasable attachment to a vacuum source (e.g., a shop vacuum or other vacuum source). In some embodiments, the vacuum attachment member can be connected to the tool support via a pivoting structure (e.g., a two-directional pivoting structure such as that described above, among various other pivoting structures).

In embodiments in which the tool includes a vacuum attachment member, a vacuum source can be connected to the vacuum attachment member and operated to provide suction of a working surface to a wall and/or to remove material (e.g., dust and/or other debris) from a working surface via one or more apertures and/or channels in the tool support and/or in one or more layers attached thereto.

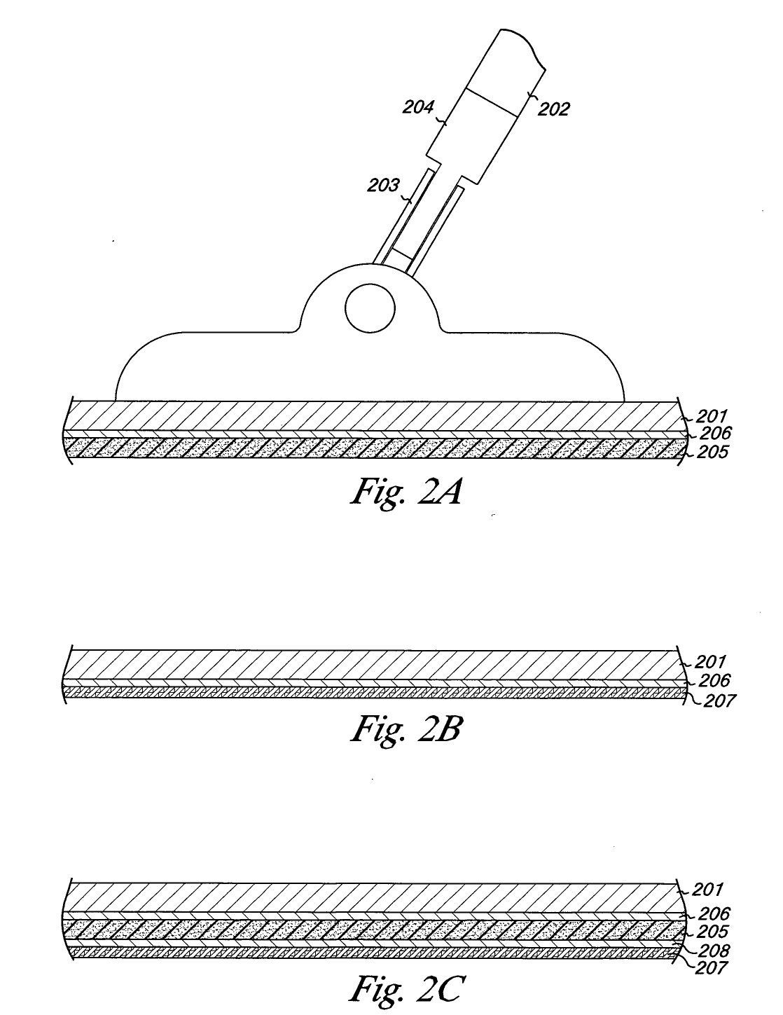

For example, FIG. 2A illustrates a side view of the embodiment of FIG. 1. FIG. 2A illustrates a support 201 having an attachment layer 206 connected thereto. In various embodiments, the attachment layer is, for example, hook and loop fasteners that can be utilized to releasably attach one or more of the layers of the device head, e.g. support 201 and pad 205, to one another. The attachment layer can include a number of fastening mechanisms including but not limited to, glues, epoxies, and other mechanical attachment structures, to name a few.

FIG. 2B illustrates a side view of another embodiment of a device head. The embodiment illustrated in FIG. 2B includes a support 101, a working material 207, and an attachment layer 206 that attaches the support 201 to the working material 207. In this embodiment, the device can have a low profile and can distribute force more directly to the material 207.

In FIG. 2B, the working material is shown as an abrasive material, such as sand paper. The working material can be any material suitable for conditioning a surface. Such materials include, but are not limited to abrasives, polishers, and liquid applicators for the application of paints, stains, and the like.

For example, in some embodiments, the working material can include a rigid backing having a number of ultra hard particles provided thereon. The ultra hard particles can be particles of various materials. As used herein, ultra hard particles refers to particles of materials having a hardness of at least 7 on a Mohs hardness scale in which diamond has a hardness of 10. Examples of ultra hard materials include tungsten carbide, silicon carbide, boron carbide, aluminum oxide, and steel, among others.

In various embodiments, the rigid backing can reduce or prevent the ultra hard particles from damaging the backing by penetrating the backing while the tool is applied to a working surface, as can occur with working materials having non-rigid backings (e.g., sandpaper or other abrasives having non-rigid backings). In such embodiments, the rigid backing can be replaceably attached to the tool support such as via releasable fastening structures including mechanical and/or chemical structures. Suitable mechanical structures include hook and loop attachments among others. Suitable chemical structures include releasable glues, adhesives, epoxies, and the like. One suitable adhesive is a pressure sensitive adhesive (PSA).

In embodiments in which the working material includes a rigid backing, the rigid backing can be formed of various metals such as stainless steel, among other rigid materials.

In embodiments in which the working material includes a rigid backing, the particles can be provided thereon in various manners. For example, the particles can be brazed on the rigid backing, and/or can be adhered to the rigid backing via an epoxy and/or other adhesive suitable for permanently adhering the particles to the rigid backing.

In various embodiments, the working material can include a grit size of less than or equal to an ISO (international organization for standardization) 6344 standard size of P24. That is, in such embodiments the coarseness of the grit is P24 or coarser. In such embodiments, the coarseness and/or hardness of the working material can be beneficial in applications such as scoring EPS (Expanded Polystyrene) foam or removing some ceiling textures, among other applications.

In embodiments in which the working material includes a rigid backing, the rigid backing can have various shapes as described herein. For instance, in some embodiments, the rigid backing can have a periphery having at least five points equidistant from a center of the tool support. In some embodiments the shape of the rigid backing can be the same as the shape of the tool support and/or a pad attached thereto.

FIG. 2C illustrates a side view of another embodiment of a device head. The embodiment illustrated in FIG. 2C includes a support 201, a pad 205, an attachment layer 206 that attaches the support 201 to the pad 205, a working material 207, and an attachment layer 208 that attaches the working material 207 to the pad 205. In this embodiment, the pad 205 can be utilized, for example, to cushion the force of the support 201 to the working material 207. Those skilled in the art will understand that the pad 205 can have a working material formed on the pad, or that the pad can be constructed of a working material, and therefore there would be no need for an attachment layer to be utilized between the pad and the working material.

FIG. 2C illustrates the use of an attachment layer 206, such as for example hook and loop fasteners, that can be utilized to releasably attach the working material 207 to the support 201. FIG. 2C also illustrates the use of a working material 207 attached to the lower surface of the pad 205 by an attachment layer 208. Those skilled in the art will understand that any fastening mechanisms can be utilized for the attachment of any of the layers, such as support 201, pad 205, attachment layers 206 and 208, working material 207, and the like, to one another.

Those skilled in the art will understand that embodiments utilizing one or more releasable fastening mechanisms can rapidly change the types of working materials that can be utilized and can add pads to the device without having to remove the handle from the head of the device and attach a new head to the handle.

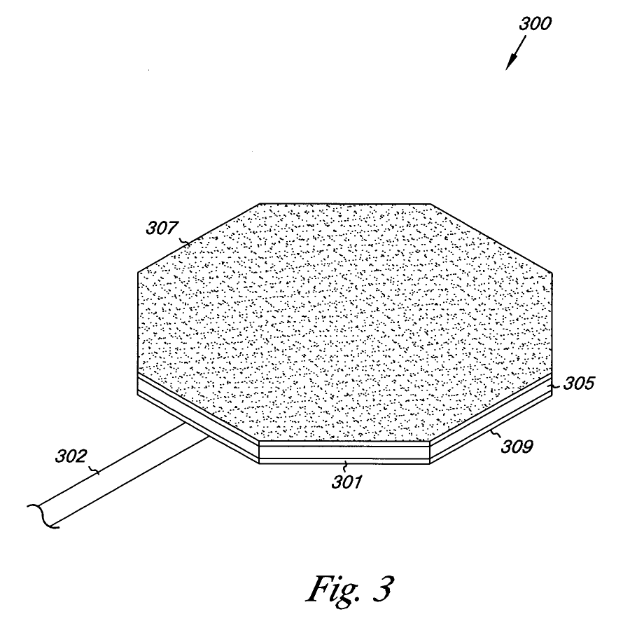

FIG. 3 illustrates a bottom view of another embodiment of a device head 300 attached to a handle 302. The embodiment shown in FIG. 3 includes a tool support 301, a handle 302, a pad 305 and a working material 307. In this embodiment, the periphery 309 of the support 301 has a polygonal shape.

In this embodiment, the periphery 309 has eight sides. This embodiment also includes at least five points on the periphery 309 that are equidistant from the center of the tool support 301. In this manner the head 300 is resistant to tipping. In this embodiment, the support 301 is an equilateral polygon. The polygon has at least four intersecting edges that are equidistant from the center of the support 301. Those skilled in the art will understand that the support 301 can have any number of sides or can be circular in shape. For example, in one embodiment, the tool support can have at least 4 intersecting edges equidistant from a center of the support.

The device includes a handle 302 attached to tool support 301. The tool support 301 has a pad 305 attached thereto. The pad 305 can be constructed from a working material or, as shown in FIG. 3, can have a working material 307 attached to the pad 305.

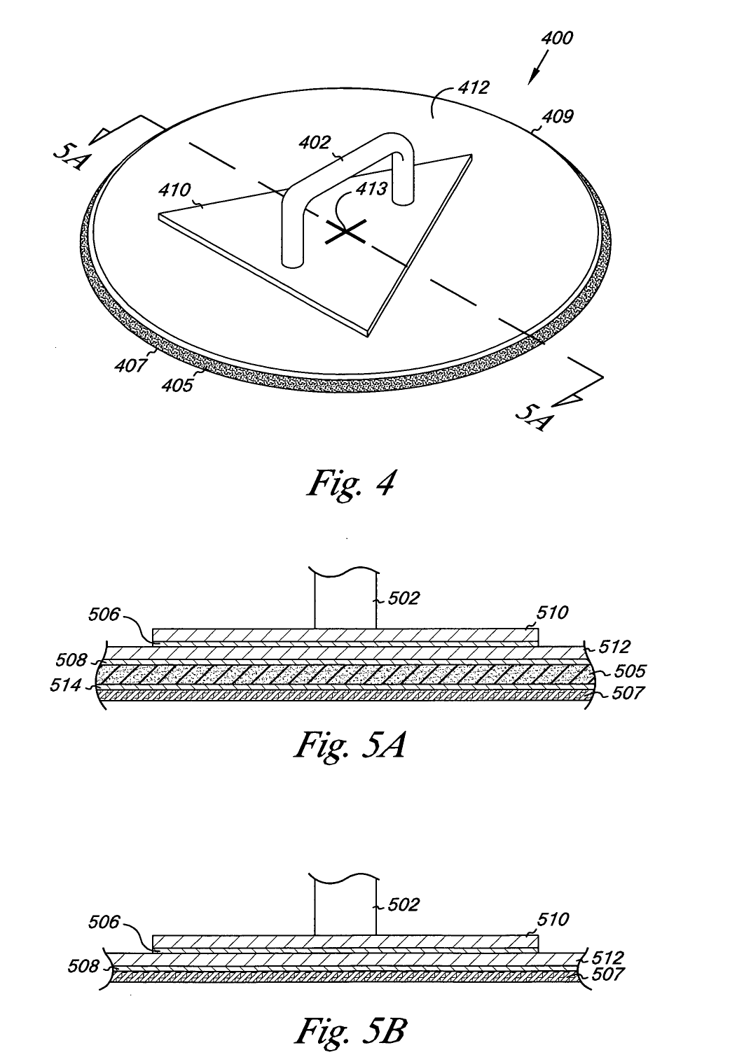

FIG. 4 illustrates a top perspective view of an embodiment of a device head 400, such as described above, attached to a handle 402. The device head 400 includes a body that is separable into at least two parts. For example, in the embodiment shown in FIG. 4, the body includes a first tool support 410 having a handle 402. In the embodiment shown in FIG. 4, the elongate handle 402 is a grasping handle, however the invention is not so limited. A grasping handle 402 as shown in FIG. 4, is a handle proximal to the head 400 that can be grasped by a user's hand.

The support 410 is releasably attached to a second tool support 412. In this way, a user can utilize the second tool support 412, for example, for sanding a broad area of a surface, such as a wall. The user can then remove the second tool support 412 and utilize the first tool support 410, for example, to sand the corners or edges of the surface by attaching a working surface to the first tool support 410.

If the second tool support 412 is needed again, the second tool support can be reattached to the first tool support 410. Those skilled in the art will understand from reading this disclosure that the first and second tool supports do not need to be directly attached, but rather, can have one or more layers, such as pads and attachment layers, among others, between them as the same have been described herein. In this manner, the embodiment of the device shown in FIG. 4 allows for a first and second head to be rapidly deployed and can allow for a user to change tools without having to remove the handle from the head of the device and attach a new head to the handle.

As shown in FIG. 4, this embodiment includes a circular second tool support 412 that has points on a periphery 409 equidistant from the center 413 of the support 412. This enables the device to maintain its stability and reduce the tendency of the device to flip onto its side. Additionally, embodiments utilizing a uniformly increased distance of the device's outside edges from the center of the device benefit from a reduced ability of the device to flip, e. g. obviates any proclivity of the device to upset or flip in a direction of motion.

FIG. 5A illustrates a side view of the embodiment of FIG. 4. The embodiment illustrated in FIG. 5A includes a first tool support 510, an attachment layer 506 that attaches the first tool support 510 to a second tool support 512, a pad 505, an attachment layer 508 that attaches the second tool support 512 to the pad 505, and an attachment layer 514 that attaches the pad 505 to a working material 507. In this manner, the pad 505 can be utilized, for example, to cushion the force of the second support 512 to the working material 507.

Those skilled in the art will understand that one type, or several different types of an attachment layers can be utilized to attach one or more of the layers of the head of the device, e.g. tool supports, working materials, pads, and the like. For example, those skilled in the art will understand that one or more of the attachment layers 506, 508, and 514 can be releasably attached to allow for removal of one or more layers of the head and attachment of other layers.

FIG. 5B illustrates a side view of another embodiment of a device head. The embodiment illustrated in FIG. 5B includes a first tool support 510 an attachment layer 506, a second tool support 512, a working material 507, and an attachment layer 508 that attaches the second tool support 512 to the working material 507.

FIG. 5B illustrates the use of attachment layers 506 and 508, such as for example hook and loop fasteners, that can be utilized to releasably attach the first tool support 510 to the second tool support 512.

FIG. 5B also illustrates the use of a working material 507 attached to the second support 512 by an attachment layer 506. In this manner, the device can have a low profile and the second support 512 can distribute force directly to the material 507.

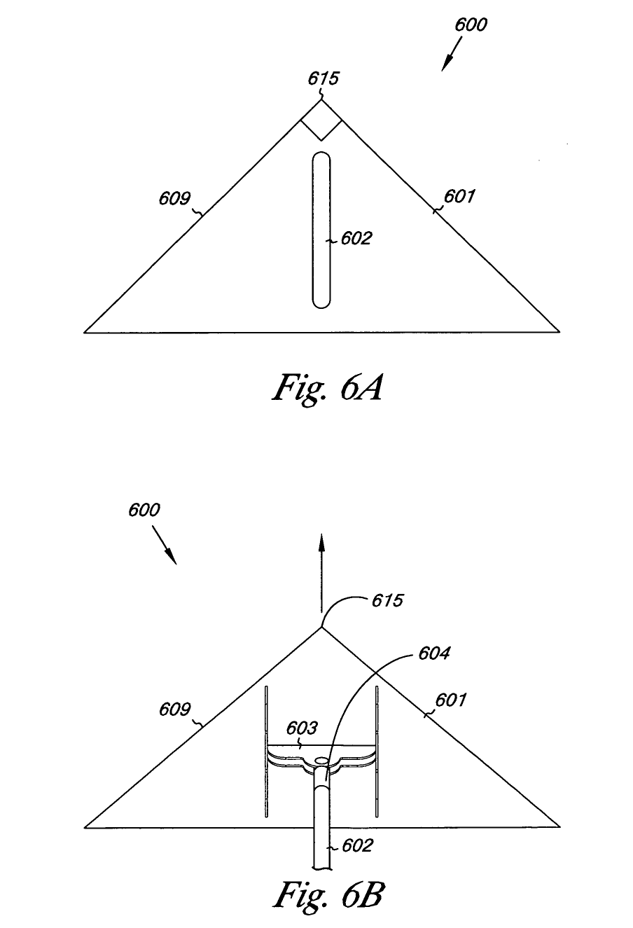

FIG. 6A illustrates a top view of another embodiment of a device head 600 attached to a handle 602 as described above. In FIG. 6A, the embodiment includes a support 601 and a handle 602. The support 601 includes a right angle 615 defined by the periphery 609 of the support 601. In this embodiment, the right angle 615 provides a surface that is configured to work in right angle corners. This is particularly useful in working on surfaces in building such as floors, ceilings, and walls where most surfaces are at right angles to adjacent surfaces. Further, by having an angle that is 90 degrees or greater creates a wider triangle and the wide sides of the triangle act to reduce the tendency of the device to flip onto its sides. In one embodiment, the handle 602 is oriented such that a length of the handle 602 is perpendicular to a hypotenuse side of the support 601, as shown in FIG. 6A.

FIG. 6B illustrates a top view of another embodiment of a device head attached to a handle. In FIG. 6B the embodiment includes, a support 601 and a handle 602. The support 601 includes an obtuse angle 615 defined by the periphery 609 of the support 601. By having an angle that is 90 degrees or greater it creates a wider triangle and the wide sides of the triangle act to reduce the tendency of the device to flip onto its sides.

FIG. 7 illustrates a cross sectional view of a tool having a vacuum attachment member 720 according to an embodiment of the present disclosure. In the embodiment illustrated in FIG. 7, the vacuum attachment member 720 is connected to a tool support 701. The tool support can be a rigid tool support made of any rigid material such as various metals and/or rigid plastics, among various other rigid materials.

In the embodiment shown in FIG. 7, the vacuum attachment member 720 is connected to the tool support via a pivoting structure similar to that described above in FIG. 1. In the embodiment illustrated in FIG. 7, the vacuum attachment member includes a connector member 721 that includes an outlet 726 for releasable attachment to a vacuum source.

The connector member can be attached to a vacuum source in any suitable manner. For example, the outlet can be threaded and/or tapered in various embodiments for receiving an end of a hollow pole or hose (not shown) which can, in turn, be connected to a vacuum source (e.g., a portable type vacuum or other vacuum source).

As illustrated in the embodiment of FIG. 7, the connector member is hollow and can provide fluid communication between outlet 726 and a vacuum chamber 723 of tool support 701. In some embodiments, the connection between the vacuum source and the tool can be made at the surface of the tool support rather than through the pivoting structure.

In various tool embodiments, the tool support can include various numbers of layers attached to a lower surface of the tool support. In the embodiment illustrated in FIG. 7, the tool support 701 includes a working material 707 attached to a lower surface 722 of the tool support via an attachment layer 706.

The working material can be replaceably attached to the lower surface 722 of the tool support. That is, attachment layer 706 can be a fastening mechanism such as a hook and loop fastening structure or an adhesive, among various other fastening mechanisms, allowing for the working material to be attached to the tool support in a releasable manner such that the working material can be replaced (e.g., with a different working material or other layer).

In the embodiment illustrated in FIG. 7, the working material 707 includes a rigid backing having a number of ultra hard particles provided thereon such as that described above in connection with FIG. 2B. As mentioned above, in such embodiments, the rigid backing can be replaceably attached to the tool support. In various embodiments, the rigid backing can reduce or prevent the ultra hard particles from damaging the backing by penetrating the backing while the tool is applied to a working surface, as can occur with working materials having non-rigid backings (e.g., sandpaper or other abrasives having non-rigid backings).

As mentioned above in connection with FIG. 2B, the rigid backing and ultra hard particles can be formed of various materials. For example, the rigid backing can be formed of metals such as stainless steel, among other rigid materials.

The ultra hard particles can be particles of various materials such as tungsten carbide, silicon carbide, boron carbide, aluminum oxide, and steel, among others. In various embodiments, the ultra hard particles include materials having a hardness of at least 7 on a Mohs hardness scale in which diamond has a hardness of 10.

In various embodiments, the working material 707 can include a grit size of not greater than an ISO (international organization for standardization) 6344 standard size of P24. That is, in such embodiments, the coarseness of the grit is P24 or coarser. In such embodiments, the coarseness and/or hardness of the working material can be beneficial in applications such as scoring EPS (Expanded Polystyrene) foam or removing some ceiling textures, among other applications.

In some embodiments, a pad layer can be attached to the tool support 701. In various embodiments, the pad can be air permeable to allow the passage of dust and/or debris therethrough. In such embodiments, the material itself can have air permeability properties and/or the material can have apertures formed therein for the passage of air.

In embodiments in which a pad is attached to the tool support, the pad can be a rigid, flexible, and/or resilient material and, in some embodiments, the pad can be replaceably attached to the tool support. That is, in some embodiments, the pad layer can be attached to the tool support in a releasable manner such that the pad can be replaced (e.g., with a different pad or other layer).

As discussed above, in various embodiments, the tool support and/or one or more attached layers can include one or more apertures therein to facilitate the removal of dust and/or other debris from a working surface. The one or more apertures (e.g., holes and/or channels) that can be provided in the tool support and/or any of the various layers can be of any suitable shape.

In embodiments in which the working material includes a rigid backing, the rigid backing and/or the lower surface of the tool support can include one or more apertures therethrough for providing fluid communication between the working surface and the vacuum attachment member.

In embodiments in which the working material includes a rigid backing, the tool can include a pad attached between the rigid backing and the tool support such that the rigid backing is replaceably attached to a lower surface of the pad. In such embodiments, the pad can be replaceably attached to the lower surface of the rigid tool support, such as by adhesive or a hook and loop fastening structure, among other fastening mechanisms.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature of the technical disclosure. It is submitted with the understanding that it will not be used to limit the scope of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A tool for working on a surface, comprising:
a rigid tool support;
a pad attached to a lower surface of the rigid tool support;
a working material replaceably attached to a lower surface of the pad; and
a vacuum attachment member connected to the rigid tool support, the vacuum attachment member including an outlet for releasable attachment to a vacuum source.

2. The tool of claim 1, wherein the pad is replaceably attached to the lower surface of the rigid tool support.

3. The tool of claim 1, wherein the vacuum attachment member is pivotally connected to the rigid tool support.

4. The tool of claim 1, wherein the pad is replaceably attached to the lower surface of the rigid tool support via a hook and loop fastening structure.

5. The tool of claim 1, wherein the working material includes a rigid backing having a number of ultra hard particles provided thereon.

6. The tool of claim 5, wherein the ultra hard particles have a hardness of at least 7 on a Mohs scale.

7. The tool of claim 5, wherein the rigid backing and the lower surface of the tool support include apertures therethrough for providing fluid communication between the working surface and the vacuum attachment member.

8. The tool of claim 6, wherein the rigid backing is replaceably attached to the pad via a hook and loop fastening structure.

9. The tool of claim 6, wherein the rigid backing is a stainless steel backing plate having a circular periphery.

10. A tool for working on a surface, comprising:
a tool support; and
a working material including a rigid backing having a number of ultra hard particles provided thereon, the rigid backing replaceably attached to the tool support.

11. The tool of claim 10, wherein the rigid backing is replaceably attached to a lower surface of the tool support via a hook and loop fastening structure.

12. The tool of claim 10, wherein the number of ultra hard particles have a hardness of at least 7 on a Mohs scale.

13. The tool of claim 10, wherein the working material includes a grit size of not greater than an ISO 6344 standard size of P24.

14. The tool of claim 10, wherein the number of ultra hard particles are brazed on the rigid backing.

15. The tool of claim 10, wherein the number of ultra hard particles includes a number of tungsten carbide particles.

16. The tool of claim 10, wherein the tool support and the backing plate include a periphery having at least five points equidistant from a center of the tool support.

17. The tool of claim 10, wherein the tool includes a pad attached between the rigid backing and the tool support such that the rigid backing is replaceably attached to a lower surface of the pad.

18. The tool of claim 17, wherein the pad is replaceably attached to the tool support.

19. A tool for working on a surface, comprising:
a tool support; and
a working material replaceably attached to the tool support, wherein the working material includes a rigid backing having a number of ultra hard particles permanently provided thereon.

20. The tool of claim 19, wherein the tool includes a working material that is replaceably attached to the tool support via a hook and loop fastening structure.
